(19) United States
(12) Patent Application Publication
(10) Pub. No.: US 2008/0221753 A1
(43) Pub. Date: Sep. 11, 2008

(54) Method For Selecting Audio Content To Be Played In A Vehicle

(75) Inventors: Andreas Kellner, Toa Payoh (SG); Gerd Lanfermann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,811

(22) PCT Filed: Jan. 4, 2006
(86) PCT No.: PCT/IB06/50023

§ 371 Date: Jul. 12, 2007

(30) Foreign Application Priority Data
Jan. 14, 2005 (EP) 05100216.0

(51) Int. Cl. G05D 1/00

(52) U.S. Cl. 701/36

(57) ABSTRACT

The present invention relates to a method and a system for dynamically selecting audio content items to be played in a vehicle based on driving parameters derived from the driving of the vehicle. Thereby, the selection of the audio content can be modified to the various driving conditions of the vehicle.

The present invention relates to a method and a system for dynamically selecting audio content items to be played in a vehicle based on at least one driving parameter derived from the driving of said vehicle.

Most motor vehicles are equipped with audio devices. It is a common thing to change the radio frequency while driving the motor vehicles. The reason for doing so can be of different nature. One reason may be due to bad sound quality of the played audio content since the driver might be outside the signal reception area of the broadcast station; the driver might not be interested in the audio content that is being played; or the driver might want to adapt the selected audio content to the current driving situation. For some drivers, it might be uncomfortable, and even dangerous, to listen to e.g. very fast music under driving conditions which demand high concentration of the driver, for instance under icy road conditions or heavy traffic conditions.

In GB 2373655 a radio receiver is described in which tuning information for broadcast stations is selected solely based on the physical location of the receiver of a motor vehicle. Therefore, a driver which is listening to a music station and is moving from one broadcast area to the next can be provided with tuning information of another music station in the other broadcast area, wherein the tuning information can be grouped into content categories, thereby enabling the driver to maintain a similar music category when moving from said one broadcast area to the next. In this invention the selection is restricted to the choice of broadcast stations, and the audio content category of the broadcast stations. This means that the driver can, while moving from one broadcast area to the next, maintain his/her music category. The problem with this invention is that the driver can not select the audio content items within each category. This can be very uncomfortable for the driver and influence his/her concentration level during the driving.

It is the object of the present invention to solve the above-mentioned problem.

According to a first aspect, the present invention relates to a method for dynamically selecting audio content items to be played in a vehicle based on at least one driving parameter derived from the driving of said vehicle, comprising:
detecting said at least one driving parameter, and
using said at least one driving parameter for selecting said audio content.

Therefore, the audio content items to be played in the vehicle can be modified to the various driving conditions of the vehicle and the driving behavior of various drivers of said vehicles, thus making the selection of the audio content items more personalized. This does not only make the audio listening more comfortable, but also enhances the security of the driving since e.g. the frequency of where the driver manually selects the audio content is strongly reduced. The vehicle can e.g. comprise bicycle, motor vehicle such as car, bus, motorbike, truck and the like, and the driver of the vehicles can therefore be the one driving the motor vehicle or the one riding the bike. The driving parameters can therefore comprise parameters obtained while driving said motor vehicles, or parameters obtained while riding said bike e.g. via mobile phone.

In an embodiment, said at least one driving parameter comprises at least one parameter of the group consisting of:
a speed parameter giving the traveling speed of said vehicle,
a frequency parameter giving the frequency of braking/accelerating of said vehicle, and
a driving route parameter giving the drivers familiarity of the driving route.

By using these driving parameters, the selected audio content items can therefore be adapted to the concentration level of the driver of said vehicle. A high braking/accelerating frequency is as an example indication of high concentration level of the drivers, whereas his/her familiarity of the road, which can e.g. be based on pre-stored information in the car's navigation system, might require a low concentration level. Depending on the various drivers, this could e.g. in the former case mean that relaxed music is suitable for the driver, and in the latter case that fast music might be preferred. Also, the selection of the audio content may of course be based on a combination of two or more driving parameters. Therefore, in cases where the driver is very familiar with the driving condition, but the frequency of braking/accelerating of said vehicle is high, the driver's concentration level might still be valued as being low.

In an embodiment, said at least one driving parameter comprises a time parameter giving the estimated remaining travel time of the driving/riding of said vehicle. Therefore, audio content program comprising one or more audio content items, e.g. a number of songs or a short story, can be selected for the driver for the remaining travel time, wherein each of the selected content items are adapted to the various driving conditions as described earlier. Preferably, the estimated travel time is frequently re-estimated. In cases where the estimated remaining travel time changes, these changes are preferably used for repeatedly re-scheduling the selection of the audio content program to be played in this remaining time interval.

In an embodiment, said at least one driving parameter comprises a location parameter giving the location of said vehicle. Thereby, the selection of said content items can further be based on the location of the vehicle and only be relevant when the driver of said vehicle is in a specific location or area or is heading for an area. An example of such content items is traffic messages, local advertisements, event calendar for target location and tourist information.

In an embodiment, said at least one driving parameter comprises a habit parameter reflecting the habit behavior performed by the driver. Therefore, historical relation between driving habits of a particular driver and the selection of audio content items can be used in selecting said audio content. An example of this is where a driver usually selects business news when the traffic is very heavy or based on a predefined criterion, e.g. when the vehicle has been standing still for more than five minutes. If this behavior is repeated several times, this behavior might be characterized as said habit behavior.

In an embodiment, said audio content items are comprised in a personalized audio program. Therefore, the audio content can be customized for each individual driver of said vehicle.

In a further aspect, the present invention relates to a computer readable medium having stored therein instructions for causing a processing unit to execute said method.

According to another aspect, the present invention relates to an audio selection system for dynamically selecting audio content items to be played in a vehicle based on at least one driving parameter derived from the driving of said vehicle, comprising:
at least one sensor associated to said vehicle for detecting said at least one driving parameter, and
a processor for using said at least one driving parameter for selecting said audio content.

Thereby, a system is provided which can dynamically modify the audio content items to the various drivers and driving situations.

In an embodiment, said at least one sensor comprises sensors integrated into said vehicles navigation system. Thereby, the large number of driving parameters obtained by the car navigation system can be used to adapt the audio content items to be played in said vehicle to the various driving situations.

In the following, the present invention, and in particular preferred embodiments thereof, will be described in more detail in connection with accompanying drawings in which

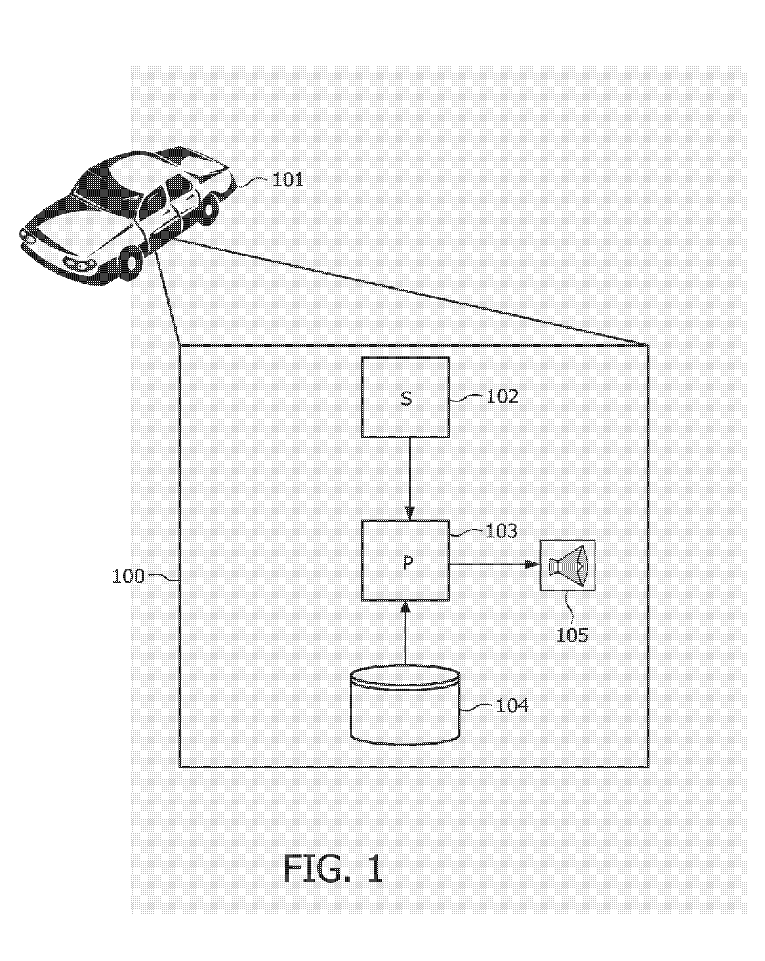

FIG. 1 illustrates one embodiment of an audio selection system according to the present invention,

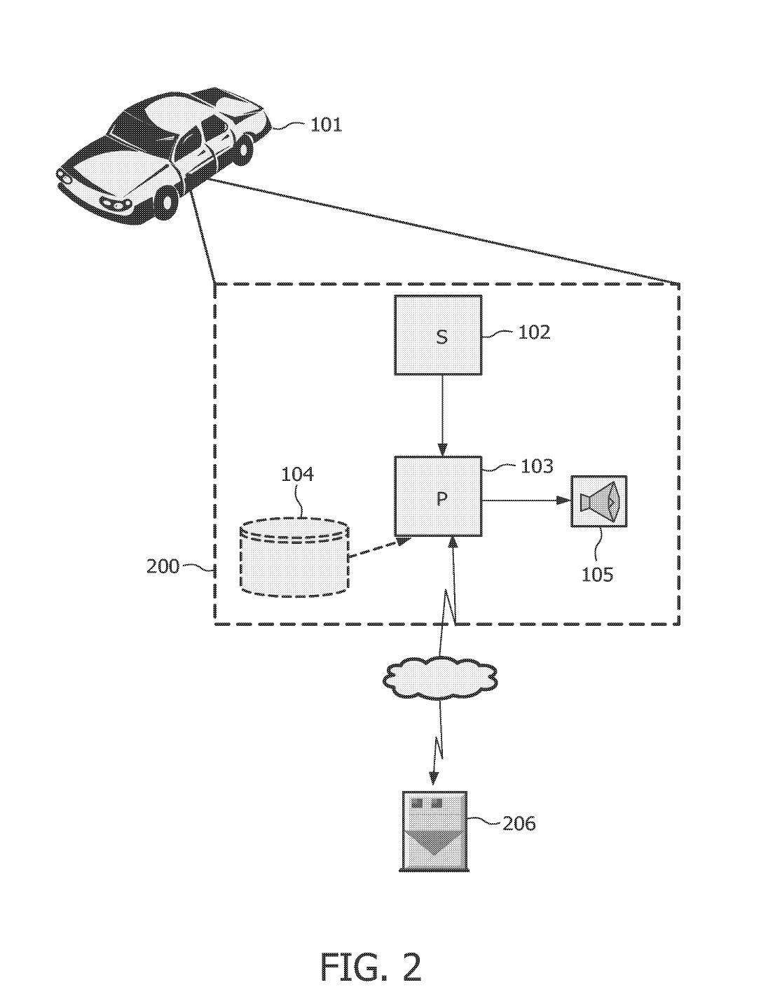

FIG. 2 shows another embodiment of an audio selection system according to the present invention,

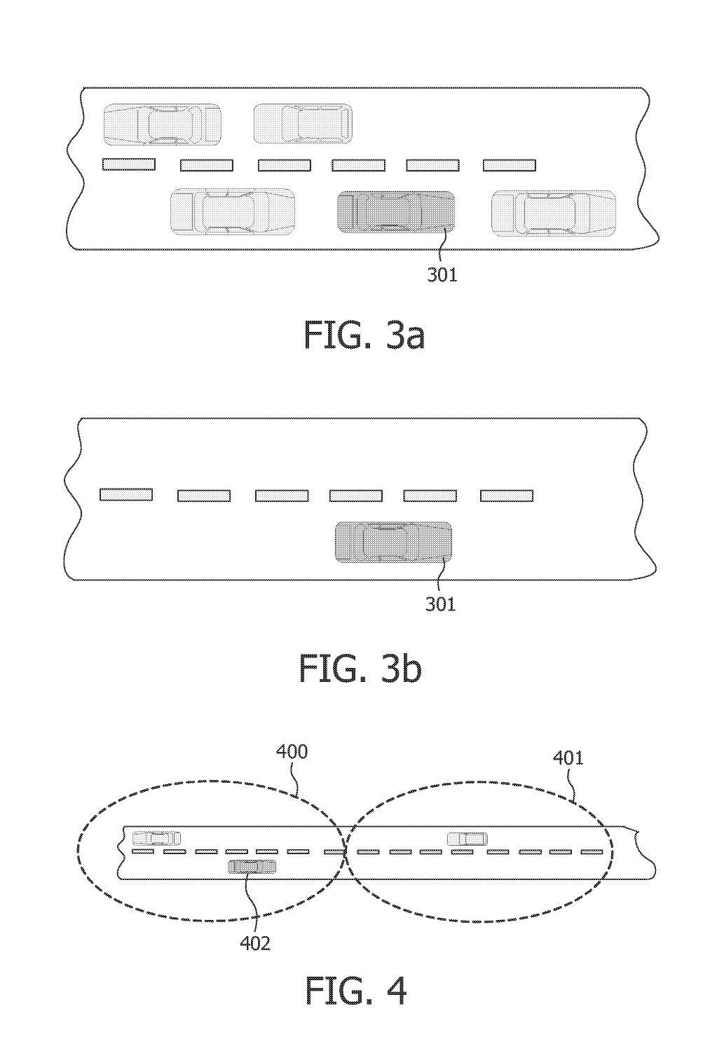

FIG. 3a shows one embodiment of the present invention, where the selected audio content is dynamically modified to the current driving situation,

FIG. 3b illustrates a traffic situation where the high concentration level of the driver in car shown in FIG. 3a has changed to low concentration level since there are no available cars, and

FIG. 4 shows one embodiment of the present invention, where the system further selects audio content items based on the current or future location of the car.

FIG. 1 illustrates one embodiment of an audio selection system 100 according to the present invention, which has been implemented in a motor vehicle, which as illustrated here is a car 101. The audio selection system 100 can of course also be implemented in all kinds of vehicles, such as a bicycle, motorbike, busses, etc.

The system 100 as illustrated here comprises at least one sensor 102, a processor 103, a storage means 104, such as a hard disc or a portable storage means, for e.g. storing audio content, and an audio device 105. Driving parameters obtained from the sensors 102 are used by the processor 103 for dynamically selecting the audio content to be played in the car 101. The sensors 102 in this embodiment can as an example be sensors comprised in the navigation system of the car 101, and/or other car sensors 102 like the board computer in the car 101. Other sensors associated with the car may inherently also be used. The essence in the present invention is to use said driving parameters detected by said sensors 102 for selecting the audio content to be played in the car 101.

The audio content stored at the storage means 104 comprises in one preferred embodiment personalized audio content items containing e.g. a mix of different content items, such as songs, news reports, traffic messages, advertisements, short stories, political commentary, gossip or interactive learning, which is customized for each individual driver. Based on the driving situation, the system 100 modifies the personalized audio content items for the various driving situations. The content stored at said storage means 104 can also comprise any kinds of audio content selected by the driver himself.

The selection of the audio content items using the driving parameters detected by said sensors 102 is in one embodiment based on set of rules (or matrix) associated to one or more sensors. As an example, the driving parameters relating to the speed of the car 101 obtained by the speed sensor can be categorized into speed intervals, wherein each speed interval is associated with a beat/minute interval of a song, i.e. how fast the song is. An example of this is where the speed 0-30 km/h is associated with a beat interval 30-60 beats/minute, 30-60 km/h with a beat interval 60-90 beats/minute, etc. Accordingly, if a speed of the case is 55 km/h, the processor selects a song within the beat interval 60-90 beats/minute. This selection can be a random selection. Of course the information relating to the beat of the songs, preferably along with additional information (how long the song is, the title of the band, when it was issued, etc), is associated with the songs. This can e.g. be via textual information attached to the song files, or stored separately and referenced via an identifier in the song file, or such information can be downloaded from external sources, e.g. the Internet, where it is identified e.g. through the song title. Also, the system 100, 200 can be adapted to scan the songs briefly in order to obtain at least some of this information.

Inherently, there can be more selection rules per sensor. In the previous example, the acceleration determined by the speed sensor can be an additional selection rule in determining the content items, e.g. which music to play. Accordingly, a multiple selection rules per sensor can be used when selecting the audio content items. An input from additional sensors can also be used as an input for selecting the audio content items. An example of this is whether it is night or day (the clock could be used here), the whether condition, the light intensity (e.g. is the car driving through a tunnel), etc.

Another type of output data from said sensors 102 to be used in selecting audio content items to be played is the remaining travel time of the car 101 obtained by the car's navigation system, wherein said audio content items are scheduled to fill a pre-defined length. This can be a short story, e.g. 30 minutes long, whereby the remaining time of driving is 30 minutes. In this case, the short story can be a “candidate” to be played for the driver. Also, several audio content items can be selected to fit into said time interval, where the audio content items are adapted to the current driving behavior of the car 101.

In one embodiment, the driver can refuse the selected content using appropriate function/button on the audio device 105, wherein the processor makes another selection, e.g. selects another song within the correct beat interval, or the next audio content item from the audio content schedule.

In one embodiment, it is the driver who accepts suggested audio content items and thereby initiates the playing of said content items. The processor 103 might even suggest one or more audio content programs, consisting of several audio content items, to the driver of the car 101, e.g. by displaying on the audio device 105 the audio content items in said programs. The user can thereby either accept one of the suggested audio content programs or request for a new suggestion.

In one embodiment, the system 100 is adapted to memorize various habit behaviors by the driver. This can be based on memorizing each tuning or selection activity performed by the user, and the frequency of performing similar tuning or selection activity. This habit behavior of the user can therefore be dynamically adapted to the content selection. This habit behavior can preferably also be “improved” by being more specific or even change the rules relating to the habit behavior of the driver. An example of such habit is when the driver is above 150 km/h, he/she usually selects classical music. In such cases, the system might follow this habit behavior of the driver and automatically select classical music as soon as the output data corresponding to the speed 150 km/h is reached.

FIG. 2 shows another embodiment of an audio selection system 200 according to the present invention to be implemented in said car 101, comprising said at least one sensor 102, processor 103, and audio device 105. In this embodiment, the system 200 is provided with means for selecting the audio content at an external database 206 via a wireless communication channel, such as the Internet. Preferably, the type and other detailed information about the audio content is associated or attached to the audio content in order to enable a correct selection of the content. The detailed information may e.g. comprise the beats/minutes in case that the content is a song, e.g. disco/rock/classic, the length of the song, etc. Of course the same is valid when the audio content comprises stories (horror story, comedy etc), news (business news, regular news, etc.).

As illustrated here, the system 200 may further be provided with said storage means 104 described previously. This could be the case where personalized audio content is regularly downloaded and stored at said storage means 104.

FIG. 3a shows one embodiment of the present invention, where the selected audio content is dynamically modified to the current driving situation. In the traffic situation shown here, the concentration level needed for driver in car 301 is high. This estimation of the concentration level can be based on the driving parameters obtained by “speed” sensors or sensors used in navigation system of the car, frequency of braking/accelerating obtained from “breaking/accelerating”-sensors, number and complexity of intersections obtained from the navigation system and familiarity of the route, i.e. whether the driver has driven here before, based on pre-stored data obtained from the navigation system. Also, the traffic density can be determined using cameras, infrared cameras or the like.

These parameters are used for predicting the required concentration level of the driver and schedule dynamically the audio content accordingly. In this case, the driver is only interested in music, slow music or music with low beats/minutes might be preferred since such music can have a relaxed effect on the driver. In one embodiment, the system 100, 200 predicts the concentration level for the road/time ahead.

The high concentration level must, however, not be based on the traffic situation. Icy road conditions can mean that a high concentration level is required although there is no traffic at all. This can be detected by e.g. temperature sensors, brake sensors, snow/ice sensors and the like, which enable detection of the actual road and weather condition.

FIG. 3b illustrates a traffic situation where the high concentration level of the driver in car 301 shown in FIG. 3a has changed to a low concentration level since there are no cars nearby, and the driver has maintained a constant speed for some time. Here it is assumed that the driving condition (weather and road) is optimal. This change in the concentration is followed by modifying the selection of the audio content to be played for the driver, e.g. faster music.

FIG. 4 shows one embodiment of the present invention, where the system 100, 200 further selects audio content items based on the current or future location of the car 402, determined by e.g. the car's navigation system. Such content items can comprise traffic messages, local advertisements, event calendar for target location and tourist information. In order to distinguish the content items between areas 400 and 401, textual data or files or the like comprising said locations and the type of the content item (e.g. local news, local advertisements, etc.) must be associated or attached to the content items. These content items are then dynamically selected to be played for the driver in the car, based on the current driving situation of the car.

As illustrated here, the driver is located in an area 400 and is heading to area 401, wherein the content items are dynamically adapted to the current position of the car 402. As the car is located in area 400 the content items can comprise local advertisements, only in this area. As soon as the car is located in area 401 the location data dynamically rule out the content items associated to area 400 and select content items associated to area 401, e.g. local advertisements in area 401.

Of course the system 100, 200 can select content items to be played for the driver in car 402 in two or more locations simultaneously, such as 400 and 401. This might be convenient when the car 402 is in area 400 and is close to approaching area 401.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements and by means of a suitably programmed computer. In a device claim enumerating several means, several of these means can be embodied by one and the same item of hardware. The mere fact that certain measures are recited in mutually different, dependent claims does not indicate that a combination of these measures cannot be used to advantage.

1. A method for dynamically selecting audio content items to be played in a vehicle (101, 301) based on at least one driving parameter derived from the driving of said vehicle (101, 301), comprising:
detecting said at least one driving parameter, and
using said at least one driving parameter for selecting said audio content.

2. A method according to claim 1, wherein said at least one driving parameter comprises at least one parameter of the group consisting of:
a speed parameter giving the traveling speed of said vehicle (101, 301),
a frequency parameter giving the frequency of braking/accelerating of said vehicle (101, 301), and
a driving route parameter giving the drivers familiarity of the driving route.

3. A method according to claim 1, wherein said at least one driving parameter comprises a time parameter giving the estimated remaining travel time of the driving of said vehicle (101, 301).

4. A method according to claim 1, wherein said at least one driving parameter comprises a location parameter giving the location of said vehicle (101, 301).

5. A method according to claim 1, wherein said at least one driving parameter comprises a habit parameter reflecting the habit behavior performed by the driver/rider of said vehicle (101, 301).

6. A method according to claim 1, wherein said audio content items are comprised in a personalized audio program.

7. A computer-readable medium having stored therein instructions for causing a processing unit to execute a method according to claim 1.

8. An audio selection system (100, 200) for dynamically selecting audio content items to be played in a vehicle (101, 301) based on at least one driving parameter derived from the driving of said vehicle (101, 301), comprising:
at least one sensor (102) associated to said vehicle (101, 301) for detecting said at least one driving parameter, and
a processor (103) for using said at least one driving parameter for selecting said audio content.

9. An audio selection system according to claim 8, wherein said at least one sensor (102) comprises sensors integrated into said vehicles navigation system.
